(19) United States
(12) Patent Application Publication
(10) Pub. No.: US 2026/0023192 A1
(43) Pub. Date: Jan. 22, 2026

(54) QUANTUM DOT DELIVERY SYSTEM FOR OIL AND GAS WELL TESTING

(71) Applicant: Sichuan Wewodon Petroleum Technology Co., Ltd., Deyang City (CN)

(72) Inventors: Yijia HE, Deyang City (CN); Mingdan HE, Deyang City (CN); Bo DENG, Deyang City (CN); Jianguo YI, Deyang City (CN); Bin WANG, Deyang City (CN)

(73) Assignee: Sichuan Wewodon Petroleum Technology Co., Ltd., Deyang City, SC (CN)

(21) Appl. No.: 18/666,871

(22) Filed: May 17, 2024

(30) Foreign Application Priority Data
Nov. 14, 2023 (CN) 2023115113251

(51) Int. Cl. G01V 8/10

(52) U.S. Cl. CPC G01V 8/10

(57) ABSTRACT

A quantum dot delivery system for oil and gas well testing comprises a quantum dot delivery device, a quantum dot labeling liquid, a sensor system, and a ground control center. The delivery device introduces quantum dot particles into oil and gas wells, realizes number and position of the particles by remote control to ensure that the particles are accurately introduced into the well. The quantum dot labeling liquid is used to introduce quantum dots into oil and gas well, the selection of labeling liquid is customized according to actual needs to adapt to different downhole environmental conditions. The sensor system, positioned in the well, monitors the quantum dots' position, distribution, and state in real-time. The ground control center remotely controls the delivery device, processes sensor data, generates test reports, and optimizes the test process in real-time. This system enables high-precision, controllable, and real-time monitoring of oil and gas well testing.

### TECHNICAL FIELD

The present invention relates to the field of oil and gas well detection and intelligent computing, and in particular to a quantum dot delivery system for oil and gas well testing.

### BACKGROUND ART

Oil and gas well testing is a critical step in oil and gas exploration to assess the physical and fluid properties of the formation within the well to determine reserves, productivity, and wellbore design, which typically involves the following key steps:

first, there is a need to extend a wellhead into a subterranean potential reservoir by drilling, which typically requires highly specialized equipment and techniques to ensure the integrity and stability of the wellbore, and once drilling is complete, the formation rock, fluid properties, and formation pressure within the wellbore need to be tested, which may be accomplished by wellbore testing tools and sensors, such as pressure sensors, temperature sensors, and flow meters, and the data collected needs to be analyzed to understand the formation properties and fluid properties within the wellbore, which typically involves complex calculations and analyses such as modeling, curve matching, and geological interpretation, oil engineers and geologists can make decisions such as determining whether to develop a wellhead, determining production strategies, and designing appropriate production equipment based on the results of the data analysis.

However, conventional oil and gas well testing methods have some limitations and challenges: conventional well testing procedures typically require days or even weeks to obtain sufficient data, which is not appropriate for situations where fast decisions are required; the high cost of testing equipment, manpower and wellbore operations and maintenance make conventional testing methods expensive; well testing may involve high-risk operations, comprising pressure release and chemical use, which may result in environmental accidents or personal injury; the data generated by conventional methods is often limited and it is difficult to obtain detailed formation information.

In order to solve the limitations of conventional methods, the present invention utilizes the potential application of quantum dot technology. Quantum dots are nano-level semiconductor material particles with unique optical and electronic properties, quantum dots have a very small size and can be used to accurately measure and monitor small changes in the formation. This accuracy is very valuable for determining the physical properties and fluid properties of the formation. Quantum dots can emit light in different wavelength ranges, which allows them to be used to monitor different types of formation rocks and fluids. By using these optical properties, non-invasive detection of formation components can be achieved. Quantum dots can be used as sensor materials, they interact with formation fluids and generate measurable signals under different conditions, which allows them to be used to monitor fluid properties and formation pressure. Compared with conventional methods, quantum dot technology can achieve faster data acquisition, which is very useful for real-time decision-making and rapid response to formation change; compared with conventional pressure release and chemical reagent injection methods, quantum dot technology is usually safer and does not involve high-risk operations. Quantum dot technology can generate richer data, comprising detailed information on temperature, pressure, composition, and formation characteristics, which is helpful for more in-depth geological interpretation and analysis.

The research background behind the present invention covers the limitations and challenges of conventional oil and gas well testing methods, as well as the potential application of quantum dot technology in this field, the present invention aims to use the advantages of quantum dot technology to provide an innovative and efficient oil and gas well testing method to meet the needs of modern oil and gas exploration, the application of this technology is expected to improve data acquisition speed, reduce costs, reduce risks, and provide more detailed formation information, which is expected to play an important role in the oil and gas industry.

### SUMMARY OF THE INVENTION

In response to the above problems, the present invention aims to provide a quantum dot delivery system for oil and gas well testing.

The objective of the present invention is realized by the following technical schemes:

a quantum dot delivery system for oil and gas well testing comprises a quantum dot delivery device, a quantum dot labeling liquid, a sensor system and a ground control center, the quantum dot delivery device delivers quantum dot particles to oil and gas wells, the delivery device realizes the number and position of the particles by remote control to ensure that the particles are accurately introduced into the well, the quantum dot labeling liquid is used to introduce quantum dots into oil and gas well, the selection of labeling liquid is customized according to actual needs to adapt to different downhole environmental conditions, the sensor system is located in the well and is used to monitor the position, distribution and state of quantum dots in real-time, it comprises a pressure sensor, a temperature sensor, a spectrum sensor, a turbidity sensor and a pH sensor to collect data in the well, the ground control center is responsible for remote control of the operation of the delivery device, receive and process sensor data, to generate test reports, and real-time adjustment and optimization of the test process, it provides an interactive interface between the user and the system for monitoring and managing the entire test process.

Further, the quantum dot delivery device accurately introduces quantum dot particles into oil and gas wells, its functions comprise: delivery precision control, remote operation, and delivery position control, the quantum dot delivery device designs a highly accurate delivery mechanism to ensure the accurate delivery of quantum dot particles, comprising precision control valves, programmable delivery devices, and quantitative pump equipment, these devices can operate reliably in the downhole environment and accurately control the number and speed of quantum dots according to requirements; the delivery device is remotely operated through the ground control center, and the operator remotely sets the delivery parameters, comprising a delivery speed and a delivery volume, the remote operation makes the delivery process more flexible and controllable; the delivery device also controls the delivery position of the quantum dots, due to different positions will produce different test results, the accuracy and repeatability of the test are ensured by accurately controlling the delivery position.

Further, the delivery position control function, a defined c(x,y) denotes a concentration of quantum dots in a wellbore, where x is a spatial coordinate and t is a time, a convection-diffusion e quation is used to describe a transmission of quantum dots:

$$\frac{\partial c ( x , t )}{\partial t} + ∇ ( u ( x , t ) c ( x , t ) ) = D {∇}^{2} c ( x , t ) ;$$

where

$$\frac{\partial c ( x , t )}{\partial t}$$

is a time derivative, ∇ is a gradient calculation, u(x, t) is a fluid velocity vector, and D is a diffusion coefficient, then, a control strategy is established to adjust a delivery position of the quantum dots, a target delivery position is set to x_{target}, and a controller is defined to adjust a fluid velocity to achieve a target position control:

$$u ( x , t ) = {u}_{base} ( x , t ) + {u}_{control} ( x , t ) ;$$

where u_{base}(x, t) is a basic fluid velocity, and u_{control}(x, t) is a control input, in order to achieve position control, an optimal control theory is used to design the control input u_{control}(x, t) as an integration of minimizing the error between the delivery position and a target position:

$$J = {\int }_{0}^{T} {[ c ( x ( t ) , t ) - {c}_{target} ( x ( t ) ) ]}^{2} dt ;$$

where J is the integration of minimizing the error between the delivery position and the target position, x(t) is a delivery position under time t, and c_{target} is a target concentration distribution.

Further, the quantum dot labeling liquid comprises quantum dot particles as a labeling substance, in addition to quantum dots, the labeling liquid also comprises solvents, stabilizers, and surfactants to ensure a dispersion stability and a fluidity of quantum dots;
spectral characteristics of quantum dot labeling liquid determine the detection and monitoring methods of quantum dots, quantum dots have tunable emission wavelengths, which make them emit light in different wavelength ranges to meet different test and detection requirements;
the labeling liquid ensures that the quantum dots can remain dispersed without agglomeration or precipitation, so as to be evenly introduced into the well during the test process, and the labeling liquid needs to have appropriate fluidity to be accurately introduced into the well through the delivery device;
the labeling liquid also has sufficient chemical stability to prevent adverse reactions or degradation with substances in the well, the labeling liquid must be used safely in the downhole environment and will not cause harm to the operator, wellbore, or environment.

Further, the sensor system comprises the pressure sensor, the temperature sensor, the spectrum sensor, the turbidity sensor, and the pH sensor to monitor the position and distribution of quantum dots in the well, it is achieved by installing multiple sensors in the wellbore, these sensors are distributed at different depths and positions, the sensor system can transmit monitoring data to the ground control center in real-time, so that the operator can keep abreast of the situation in the well, the data is transmitted by wireless communication and wired transmission, and has data processing and analysis functions, comprising data filtering, calibration, data visualization, and real-time reporting.

Further, the sensor system comprises the pressure sensor, the temperature sensor, the spectrum sensor, the turbidity sensor, and the pH sensor, as follows:

### (1) The Pressure Sensor

the pressure sensor is a bending beam pressure sensor, which:

$$δ = \frac{P {L}^{3}}{3 {Ebh}^{3}} ;$$

where P is an external pressure, δ is a deformation of a bending beam, L is a length of the bending beam, b is a breadth of the bending beam, h is a height of the bending beam, E is a Young's modulus of the bending beam, a relationship between fluid velocity and pressure is established according to a fluid dynamic equation:

$$∇ P = - {ρ}_{f} ∇ ( \frac{{V}_{f}^{2}}{2} ) ;$$

where ρ_{f} is a fluid density and V_{f} is a fluid velocity, meanwhile, the present invention also considers the stress influence on the pressure sensor in an oil and gas well environment, and constructs a stress equation:

$$σ = \frac{P {L}^{3}}{3 {bh}^{4}} ;$$

where ρ is a stress of the pressure sensor in the oil and gas well environment, and the bending of the bending beam leads to the change of a resistance value, a relationship between a resistivity change Δρ and the stress is expressed as:

$$Δ ρ = \frac{ρ G P {L}^{3}}{3 {Ebh}^{4} ( 1 - 2 v )} ;$$

where G is a shear modulus of a bending beam material, ρ is a resistivity, and ν is a Poisson's ratio;

### (2) The Temperature Sensor

for the temperature sensor, the present invention considers a relationship between a thermal resistance value and a temperature, and builds a heat transfer model, the relationship between the thermal resistance value and the temperature is expressed as follows:

$$R ( T ) = {R}_{0} ( 1 + α ( T - {T}_{0} ) ) ;$$

where R(T) is a thermal resistance value at a temperature T, R₀ is a thermal resistance value at a reference temperature T₀, T₀ is the reference temperature of the thermal resistance, and α is a temperature coefficient, for the heat transfer model, the present invention constructs the following equation:

$$\hat{ρ} \hat{c} \frac{\partial T}{\partial t} = ∇ ( k ∇ T ) + Q ;$$

where \hat{ρ} is a material density, ĉ is a specific heat capacity, k is a conductivity, and Q is a heat source;

### (3) The Spectrum Sensor

for the spectrum sensor, the present invention describes a absorption, scattering, and refraction of light through spectral transmission and is modeled as follows:

$$I ( λ ) = {ω}_{1} ( ϕ ( λ ) ε ( λ ) c * l ) + {ω}_{2} ( {I}_{0} ( λ ) {e}^{- ε ( λ ) c * l} T ( λ ) + {I}_{s} ( λ ) ) ;$$

where I(λ) is a light intensity at a wavelength λ, ϵ(λ) is a molar absorption coefficient of the substance, c* is a substance concentration, l is an optical path length, ϕ is a light source intensity, I₀(λ) is an initial light intensity, T(λ) is a reflectivity, I_{S}(λ) is a scattered light intensity, ω₁ and ω₂ are adjustment coefficients, the temperature sensor has a specific spectral response ϵ(λ) and a sensitivity S(λ), and the light intensity I(λ) is converted into an electrical signal E(λ) by the following formula:

$$E ( λ ) = ϵ ( λ ) I ( λ ) S ( λ ) ;$$

where ϵ(λ) is a spectral response of the temperature sensor, S(λ) is a sensitivity of the temperature sensor;

### (4) The Turbidity Sensor

the turbidity sensor is modeled as follows:

$${I}_{s} ( θ ) = {I}_{0} {\vert \frac{f ( θ )}{r} \vert}^{2} ;$$

where θ is a scattered angle, I_{S}(θ) is a scattered intensity, r is a distance, f(θ) is a scattered amplitude function, and I₀ is an initial light intensity;

### (4) The pH Sensor

the pH sensor is modeled as follows:

$$\hat{E} = {E}_{0} - \frac{2.303 Q T}{z F} l g ( {a H}^{+} ) ;$$

where E₀ is a standard potential of an electrode, Q is a gas constant, z is a charge number of an electrode reaction, F is a Faraday constant, Ê is a potential, and aH⁺ is a hydrogen ion activity, this formula describes a relationship between the potential Ê and the hydrogen ion activity aH⁺, pH is a measure of a negative logarithmic hydrogen ion concentration, expressed as: pH=−lg(aH⁺), a response time of the pH sensor is usually related to an electrolyte transport rate inside the electrode, the response time is described by an electrolyte transport equation:

$$\frac{d ( {a H}^{+} )}{dt} = - q ( {a H}^{+} - {a H}_{e q}^{+} ) ;$$

where q is a transmission rate constant,

$${H}_{eq}^{+}$$

is a hydrogen ion acuvity at equilibrium, and

$$\frac{d ( {a H}^{+} )}{dt}$$

is a hydrogen ion activity derivative of time t.

Further, the obtained sensor system data needs to be transmitted to the ground control center, in order to reduce a computational load of the ground control center, an edge computing technology is adopted, so that each sensor has a certain data processing ability to ensure the timeliness and reliability of data transmission, for each type of sensors, the following operations are performed:

an objective function Φ₁ᵢ of an i^{th} pressure sensor is constructed:

$${Φ}_{1 i} = \frac{{{w}_{11} ( \frac{{P}_{i} {L}_{i}^{3}}{3 E {b}_{i} {h}_{i}^{3}} - min \{ \frac{{P}_{i} {L}_{i}^{3}}{3 E {b}_{i} {h}_{i}^{3}} \vert}_{i = 1}^{N 1} \} )}{{{( {w}_{11} + {w}_{12} + {w}_{13} + {w}_{14} ) ( max \{ \frac{{P}_{i} {L}_{i}^{3}}{3 E {b}_{i} {h}_{i}^{3}} \vert}_{i = I}^{N 1} \} - min \{ \frac{{P}_{i} {L}_{i}^{3}}{3 E {b}_{i} {h}_{i}^{3}} \vert}_{i = 1}^{N 1} \} )} + \frac{{{w}_{12} ( - {ρ}_{f i} ∇ ( \frac{{V}_{f i}^{2}}{2} ) - min \{ - {ρ}_{f i} ∇ ( \frac{{V}_{f i}^{2}}{2} ) \vert}_{i = 1}^{N 1} \} )}{\begin{matrix}{( {w}_{11} + {w}_{12} + {w}_{13} + {w}_{14} ) ( max \{ - {ρ}_{f i} ∇ ( \frac{{V}_{f i}^{2}}{2} ) \vert}_{i = 1}^{N 1} \} - \\ {min \{ - {ρ}_{f i} ∇ ( \frac{{V}_{f i}^{2}}{2} ) \vert}_{i = 1}^{N 1} \} )\end{matrix}} + \frac{{{w}_{13} \frac{{P}_{i} {L}_{i}^{3}}{3 {b}_{i} {h}_{i}^{4}} - min \{ \frac{{P}_{i} {L}_{i}^{3}}{3 {b}_{i} {h}_{i}^{4}} \vert}_{i = 1}^{N 1} \}}{{{( {w}_{11} + {w}_{12} + {w}_{13} + {w}_{14} ) ( max \{ \frac{{P}_{i} {L}_{i}^{3}}{3 {b}_{i} {h}_{i}^{4}} \vert}_{i = 1}^{N 1} \} - min \{ \frac{{P}_{i} {L}_{i}^{3}}{3 {b}_{i} {h}_{i}^{4}} \vert}_{i = 1}^{N 1} \} )} + \frac{{w}_{14}}{{w}_{11} + {w}_{12} + {w}_{13} + {w}_{14}} \frac{{\frac{{ρ}_{i} {G}_{i} {P}_{i} {L}^{3}}{3 E {b}_{i} {h}_{i}^{4} ( 1 - 2 ν )} - min \{ \frac{{ρ}_{i} {G}_{i} {P}_{i} {L}^{3}}{3 E {b}_{i} {h}_{i}^{4} ( 1 - 2 ν )} \vert}_{i = 1}^{N 1} \}}{\begin{matrix}{max \{ \frac{{ρ}_{i} {G}_{i} {P}_{i} {L}^{3}}{3 E {b}_{i} {h}_{i}^{4} ( 1 - 2 ν )} \vert}_{i = 1}^{N 1} \} - \\ {min \{ \frac{{ρ}_{i} {G}_{i} {P}_{i} {L}^{3}}{3 E {b}_{i} {h}_{i}^{4} ( 1 - 2 ν )} \vert}_{i = 1}^{N 1} \}\end{matrix}}$$

where w₁₁, w₁₂, w₁₃, and w₁₄ are a deformation weight, a pressure weight, a stress weight, and a resistivity change weight, respectively, Pᵢ is a length of the bending beam of the i^{th} pressure sensor, Lᵢ is a length of the bending beam of the ith pressure sensor, bᵢ is a breadth of the bending beam of the i^{th} pressure sensor, hᵢ is a height of the bending beam of the i^{th} pressure sensor, V_{fi} is a fluid velocity of the i^{th} pressure sensor, Gᵢ is a shear modulus of the bending beam material of the i^{t}h pressure sensor, ρᵢ is the resistivity of the i^{th} pressure sensor,

$${\vert}_{i = 1}^{N 1}$$

denotes that i starts from 1 to N1 ens, N1 is a total number of pressure sensors;

an objective function Φ₂ᵢ of an i^{th} temperature sensor is constructed:

$${Φ}_{2 i} = \frac{{{R}_{0 i} ( 1 + α ( T - {T}_{0} ) ) - min \{ {R}_{0 i} ( 1 + α ( T - {T}_{0} ) ) \vert}_{i = 1}^{N 2} \}}{{{max \{ {R}_{0 i} ( 1 + α ( T - {T}_{0} ) ) \vert}_{i = 1}^{N 2} \} - min \{ {R}_{0 i} ( 1 + α ( T - {T}_{0} ) ) \vert}_{i = 1}^{N 2} \}} ;$$

where R₀ᵢ is a thermal resistance value of i^{th} temperature sensor at the reference temperature T₀,

$${\vert}_{i = 1}^{N 2}$$

denotes that i starts from 1 to N2 ends, and N2 is a total number of temperature sensors;

an objective function Φ₃ᵢ of an i^{th} spectrum sensor is constructed:

$${Φ}_{3 i} = \frac{\begin{matrix}( {ω}_{1} ( {ϕ}_{i} ( λ ) ε ( λ ) {c}_{i} * {l}_{i} ) + {ω}_{2} ( {I}_{0 i} ( λ ) {e}^{- ε ( λ ) {c}_{i}^{*} {l}_{i}} {T}_{i} ( λ ) + {I}_{si} ( λ ) ) ) - \\ {min \{ ( {ω}_{1} ( {ϕ}_{i} ( λ ) ε ( λ ) {c}_{i}^{*} {l}_{i} ) + {ω}_{2} ( {I}_{0 i} ( λ ) {e}^{- ε ( λ ) {c}_{i}^{*} {l}_{i}} {T}_{i} ( λ ) + {I}_{si} ( λ ) ) ) \vert}_{i = 1}^{N 3} \}\end{matrix}}{\begin{matrix}{max \{ ( {ω}_{1} ( {ϕ}_{i} ( λ ) ε ( λ ) {c}_{i} * {l}_{i} ) + {ω}_{2} ( {I}_{0 i} ( λ ) {e}^{- ε ( λ ) {c}_{i}^{*} {l}_{i}} {T}_{i} ( λ ) + {I}_{si} ( λ ) ) ) \vert}_{i = 1}^{N 3} \} - \\ {min \{ ( {ω}_{1} ( {ϕ}_{i} ( λ ) ε ( λ ) {c}_{i}^{*} {l}_{i} ) + {ω}_{2} ( {I}_{0 i} ( λ ) {e}^{- ε ( λ ) {c}_{i}^{*} {l}_{i}} {T}_{i} ( λ ) + {I}_{si} ( λ ) ) ) \vert}_{i = 1}^{N 3} \}\end{matrix}}$$

where

$${c}_{i}^{*}$$

is a substance concentration of the i^{th} spectrum sensor, lᵢ is an optical path length of the i^{th} spectrum sensor, ϕᵢ is a light source intensity of the i^{th} spectrum sensor, I₀ᵢ(λ) is an initial light intensity of the i^{th} spectrum sensor, Tᵢ(λ) is a reflectivity of the i^{th} spectrum sensor, Iₛᵢ(λ) is a scattered light intensity of the i^{th} spectrum sensor,

$${\vert}_{i = 1}^{N 3}$$

denotes that i starts from 1 to N3 ends, and N3 is the total number of spectrum sensors;

an objective function Φ₄ᵢ of an i^{th} turbidity sensor is constructed:

$${Φ}_{4 i} = \frac{{I}_{oi} {\vert \frac{{f}_{i} ( θ )}{{r}_{i}} \vert}^{2} - min \{ {I}_{oi} {\vert \frac{{f}_{i} ( θ )}{{r}_{i}} \vert}^{2} \vert \begin{matrix}N 4 \\ i = 1\end{matrix} \}}{max \{ {I}_{oi} {\vert \frac{{f}_{i} ( θ )}{{r}_{i}} \vert}^{2} \vert \begin{matrix}N 4 \\ i = 1\end{matrix} \} - min \{ {I}_{oi} {\vert \frac{{f}_{i} ( θ )}{{r}_{i}} \vert}^{2} \vert \begin{matrix}N 4 \\ i = 1\end{matrix} \}} ;$$

where I₀ᵢ(λ) is an initial light intensity of the i^{th} turbidity sensor, rᵢ is a distance of the i^{th} turbidity sensor, fᵢ(θ) is a scattered amplitude function of the i^{th} turbidity sensor,

$$\vert \begin{matrix}N 4 \\ i = 1\end{matrix}$$

denotes that i starts from 1 to N4 ends, and N4 is the total number of turbidity sensors;

an objective function Φ₅ᵢ of an i^{th} pH sensor is constructed:

$${Φ}_{5 i} = \frac{{E}_{oi} - \frac{2.303 QT}{zF} l ℊ ( {aH}_{i}^{+} ) - min \{ {E}_{oi} - \frac{2.303 QT}{zF} l ℊ ( {aH}_{i}^{+} ) \vert \begin{matrix}N 5 \\ i = 1\end{matrix} \}}{max \{ {E}_{oi} - \frac{2.303 QT}{zF} l ℊ ( {aH}_{i}^{+} ) \vert \begin{matrix}N 4 \\ i = 1\end{matrix} \} - min \{ {E}_{oi} - \frac{2.303 QT}{zF} l ℊ ( {aH}_{i}^{+} ) \vert \begin{matrix}N 5 \\ i = 1\end{matrix} \}} ;$$

E₀ᵢ is a standard potential of the electrode of the i^{th} pH sensor, aH⁺ is a hydrogen ion activity of the i^{th} pH sensor,

$$\vert \begin{matrix}N 5 \\ i = 1\end{matrix}$$

denotes that/starts from 1 to N5 ends, and N5 is the total number of pH sensors;

the objective functions of pressure sensors, temperature sensors, spectrum sensors, turbidity sensors, and pH sensors are summarized as follows:

$$Φ = {o}_{1} {\sum }_{i = 1}^{N 1} {Φ}_{1 i} + {o}_{2} {\sum }_{i = 1}^{N 2} {Φ}_{2 i} + {o}_{3} {\sum }_{i = 1}^{N 3} {Φ}_{3 i} + {o}_{4} {\sum }_{i = 1}^{N 4} {Φ}_{4 i} + {o}_{5} {\sum }_{i = 1}^{N 5} {Φ}_{5 i} ;$$

where Φ is an objective function, and o₁, o₂, o₃, o₄, and o₅ are adjustment weights, in order to find the optimal objective function suitable for the oil and gas well testing environment, it is necessary to explore the adjustment weights, the steps are as follows:

$${o}_{id}^{p} = {o}_{i 5} + cos ( 2 π \frac{p}{h} ) {step}_{i} ;$$

where

$${o}_{id}^{p}$$

is a position or a i^{th} adjustment weight in a d dimension, d∈{1,2,3,4,5}, oᵢ₅ is a position of the i^{th} adjustment weight in the 5 dimensions, stepᵢ is a moving step of the i^{th} adjustment weight, h is a number of directions, h<360, p is a direction number, p∈[1, h], in order to expand the number of samples, the present invention expands the number of samples by convening: the current optimal adjustment weight is

$${o}_{id}^{best} ,$$

and the optimal adjustment weight

$${o}_{i d}^{best}$$

is used to randomly select the sample points in the number domain radius M by Monte Carlo, each sample point approaches the objective function in steps of stepᵢ, which is expressed as follows:

$${o}_{jd}^{k + 1} = {o}_{jd}^{k} + {step}_{j} \frac{{o}_{j d}^{qbest , k} - {o}_{j d}^{k}}{\vert {o}_{jd}^{qbest , k} - {o}_{jd}^{k} \vert} ;$$

where

$${o}_{j d}^{k}$$

is a position of the current j^{th} adjustment weight in the d dimension,

$${o}_{j d}^{k + 1}$$

is a position of the j^{th} adjustment weight in the d dimension after the (k+1)^{th} iteration, stepⱼ is a moving step of the j^{th} adjustment weight,

$${o}_{j d}^{gbest , k}$$

is a global optimal position of the j^{th} adjustment weight in the d dimension after the k^{th} iteration, if a distance between the randomly selected sample points and the adjustment weight corresponding to the global optimal position is less than a threshold value, the defending and attacking behaviors will occur, that is, if the randomly selected sample points have higher fitness, the randomly selected sample points attack successfully, and the adjustment weight corresponding to the original global optimal position fails, the new randomly selected sample points will replace the position of the adjustment weight corresponding to the original global optimal position:

$${o}_{id}^{k + 1} = {o}_{id}^{k} + η {step}_{i} \vert {o}_{jd}^{Gbest , k} - {o}_{id}^{k} \vert ;$$

where

$${o}_{i d}^{k}$$

is a position of unie current i^{th} adjustment weight in the d dimension,

$${o}_{id}^{k + 1}$$

is a position of the i^{th} adjustment weight in the d dimension after the (k+1)^{th} iteration, η is a learning factor,

$${o}_{j d}^{Gbest , k}$$

is an ideal global optimal position of the i^{th} adjustment weight in the d dimension after the k^{th} iteration under a priori condition, and the optimal adjustment weight suitable for the oil and gas well environment is explored through convergence iteration.

Further, the ground control center has the functions of control, monitoring and management, which are used to monitor a state of quantum dot injection equipment, monitor a position and movement of delivery vehicles, and monitor a real-time process of quantum dot delivery, the ground control center is responsible for scheduling and planning a path of the delivery vehicle to ensure that the quantum dots can be accurately and efficiently delivered to an oil and gas well testing area, a stable communication link needs to be established between the ground control center and the delivery vehicle to transmit commands, data and real-time information, which is realized through wireless communication technology and satellite communication, the ground control center is responsible for controlling parameters in the delivery process to ensure the accuracy and efficiency of the delivery, the ground control center can monitor and respond to faults of the delivery equipment and vehicles in time, and perform maintenance tasks to ensure the normal operation of the system, the ground control center will record and store data during the delivery process, comprising real-time location, delivery parameters, and wellhead information, the ground control center needs to develop safety protocols and procedures to ensure the safety of the delivery process and prevent accidents and leakage.

Further, the ground control center has a monitoring and display system, a communications equipment, a calculation and control system, a fault detection and maintenance tool, and a geographic information system, as follows:
the monitoring and display system: for real-time monitoring of the delivery process, comprising surveillance cameras, sensors, and large screen display;
the communications equipment: used to establish communication links with delivery vehicles, comprising satellite communications, GPS trackings, and data transmissions;
the calculation and control system: used to control delivery parameters, path planning, and data processing, comprising high-performance computers and control terminals;
the fault detection and maintenance tools: tools for detecting equipment faults and performing remote maintenance and diagnoses;
the geographic information system: for map display, path planning, and geographic data analysis.

Advantageous effects of the present invention: the present invention uses quantum dot technology, which has very small size and highly adjustable optical properties, so as to achieve high-precision measurement and high-resolution monitoring of the formation, the sensor can capture small formation changes based on the characteristics of quantum dots, and provides reliable data for more accurate geological interpretation to monitor formation pressure and fluid properties, the multi-functionality increases the flexibility of the test system, and can be adapted to different types of oil and gas well testing; conventional oil and gas well testing usually requires days or weeks to obtain sufficient data, the quantum dot sensor of the present invention has real-time data acquisition capability, to achieve more rapid formation monitoring, which facilitates real-time decision-making and rapid response to formation changes, the present invention utilizes edge computing technology to impart computing power to the sensor system, reducing the cost of the testing process and reducing the testing cycle, thereby reducing the overall cost, and the quantum dot technology of the present invention are generally safer, do not involve high risk operations, and can generate richer data, facilitate deeper geological interpretation and analysis, and provide more insight into oil and gas well testing.

In order to reduce the calculation load of the ground control center, the edge calculation technology is adopted to make each sensor have a certain data processing capacity, so as to ensure the timeliness and reliability of data transmission, and each sensor is refined; mathematical models suitable for oil and gas well environment are established for pressure sensors, temperature sensors, spectrum sensors, turbidity sensors and pH sensors, respectively, for the pressure sensor, the effects of deformation, pressure, stress and resistivity changes on the pressure sensor are considered in the present invention, and the deformation weight, pressure weight, stress weight and resistivity change weight are used to dynamically adjust the proportion of each influencing factor, improving the adaptability of the system. In addition, the present invention also constructs an objective function, and in order to find the optimal adjustment weight, a heuristic algorithm suitable for the present invention is proposed, and the concepts of convening, defending and attacking are proposed, wherein the convening is taking the current optimal adjustment weight as the centre, and randomly select the sample points in the number domain radius M by Monte Carlo; the defending is taking the adjustment weight corresponding to the original global optimal position to participate in the calculation of the objective function; and the attacking is taking the calculation behaviour of the objective function when the distance between the randomly selected sample points and the adjustment weight corresponding to the global optimal position is less than a threshold value, and updating and iterating the position of the adjustment weight are performed, the convergence trend of the objective function is examined, and the optimal adjustment weight is obtained.

The present invention provides a quantum dot delivery system for oil and gas well testing with the advantages of high-precision, high-resolution, real-time data acquisition and multi-functionality, which can not only improve the output and return rate and reduce risks, but also contribute to environmental protection and sustainable development, therefore, the present invention has wide commercial value and social impact, and is expected to attract wide attention and application in the field of oil and gas exploration and testing.

### BRIEF DESCRIPTION OF DRAWINGS

The accompanying drawings are used to further illustrate the present invention, but the embodiments in the accompanying drawings do not constitute any limitation of the present invention, and those ordinarily skilled in the art can obtain other drawings according to these drawings without creative work.

FIG. 1 is a schematic diagram of a structure of the present invention.

### DETAILED DESCRIPTION OF THE EMBODIMENTS

The present invention will be further described below with reference to the embodiments.

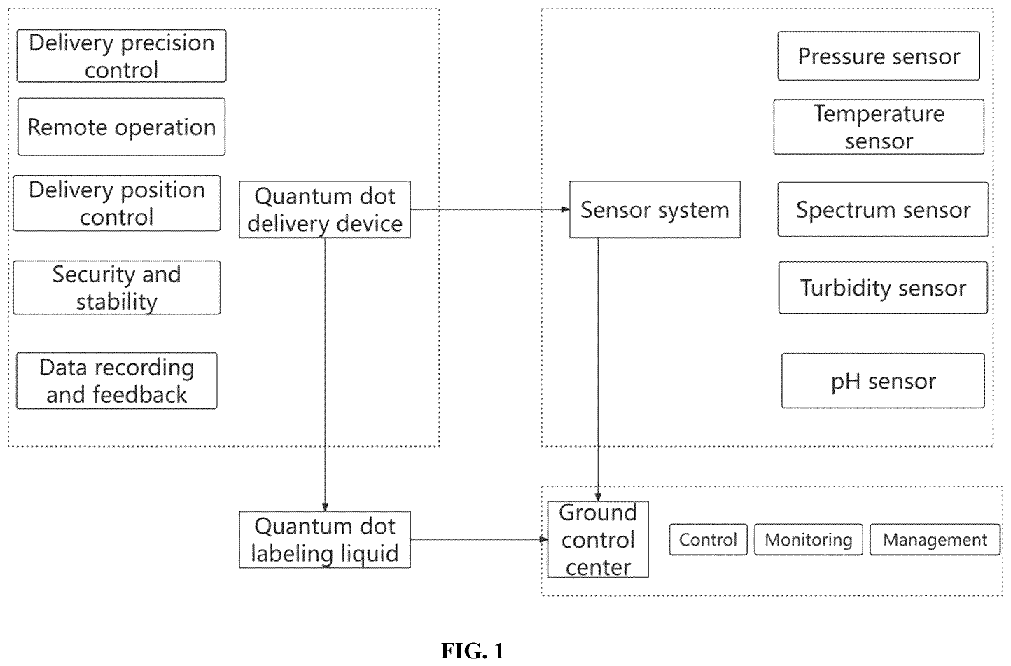

With reference to a schematic diagram of the structure of the present invention in FIG. 1, a quantum dot delivery system for oil and gas well testing comprises a quantum dot delivery device, a quantum dot labeling liquid, a sensor system and a ground control center, the quantum dot delivery device delivers quantum dot particles to oil and gas wells, the delivery device realizes the number and position of the particles by remote control to ensure that the particles are accurately introduced into the well, the quantum dot labeling liquid is used to introduce quantum dots into oil and gas well, the selection of labeling liquid is customized according to actual needs to adapt to different downhole environmental conditions, the sensor system is located in the well and is used to monitor the position, distribution and state of quantum dots in real-time, it comprises a pressure sensor, a temperature sensor, a spectrum sensor, a turbidity sensor and a pH sensor to collect data in the well, the ground control center is responsible for remote control of the operation of the delivery device, receive and process sensor data, to generate test reports, and real-time adjustment and optimization of the test process, it provides an interactive interface between the user and the system for monitoring and managing the entire test process.

Specifically, the quantum dot delivery device accurately introduces quantum dot particles into oil and gas wells, its functions comprise: delivery precision control, remote operation, and delivery position control, the quantum dot delivery device designs a highly accurate delivery mechanism to ensure the accurate delivery of quantum dot particles, comprising precision control valves, programmable delivery devices, and quantitative pump equipment, these devices can operate reliably in the downhole environment and accurately control the number and speed of quantum dots according to requirements; the delivery device is remotely operated through the ground control center, and the operator remotely sets the delivery parameters, comprising a delivery speed and a delivery volume, the remote operation makes the delivery process more flexible and controllable; the delivery device also controls the delivery position of the quantum dots, due to different positions will produce different test results, the accuracy and repeatability of the test are ensured by accurately controlling the delivery position.

Specifically, the delivery position control function, a defined c(x,y) denotes a concentration of quantum dots in a wellbore, where x is a spatial coordinate and t is a time, a convection-diffusion equation is used to describe a transmission of quantum dots:

$$\frac{\partial c ( x , t )}{\partial t} + ∇ ( u ( x , t ) c ( x , t ) ) = D {∇}^{2} c ( x , t ) ;$$

where

$$\frac{\partial c ( x , t )}{\partial t}$$

is a time derivative, ∇ is a gradient calculation, u(x, t) is a fluid velocity vector, and D is a diffusion coefficient, then, a control strategy is established to adjust a delivery position of the quantum dots, a target delivery position is set to x_{target}, and a controller is defined to adjust a fluid velocity to achieve a target position control:

$$u ( x , t ) = {u}_{base} ( x , t ) + {u}_{control} ( x , t ) ;$$

where u_{base}(x, t) is a basic fluid velocity, and u_{control}(x, t) is a control input, in order to achieve position control, an optimal control theory is used to design the control input u_{control}(x, t) as an integration of minimizing the error between the delivery position and a target position:

$$J = {\int }_{0}^{T} {[ c ( x ( t ) , t ) - {c}_{target} ( x ( t ) ) ]}^{2} dt ;$$

where J is the integration of minimizing the error between the delivery position and the target position, x(t) is a delivery position under time t, and c_{target} is a target concentration distribution.

Specifically, the quantum dot labeling liquid comprises quantum dot particles as a labeling substance, in addition to quantum dots, the labeling liquid also comprises solvents, stabilizers, and surfactants to ensure a dispersion stability and a fluidity of quantum dots;

spectral characteristics of quantum dot labeling liquid determine the detection and monitoring methods of quantum dots, quantum dots have tunable emission wavelengths, which make them emit light in different wavelength ranges to meet different test and detection requirements;

the labeling liquid ensures that the quantum dots can remain dispersed without agglomeration or precipitation, so as to be evenly introduced into the well during the test process, and the labeling liquid needs to have appropriate fluidity to be accurately introduced into the well through the delivery device;

the labeling liquid also has sufficient chemical stability to prevent adverse reactions or degradation with substances in the well, the labeling liquid must be used safely in the downhole environment and will not cause harm to the operator, wellbore, or environment.

Specifically, the sensor system comprises the pressure sensor, the temperature sensor, the spectrum sensor, the turbidity sensor, and the pH sensor to monitor the position and distribution of quantum dots in the well, it is achieved by installing multiple sensors in the wellbore, these sensors are distributed at different depths and positions, the sensor system can transmit monitoring data to the ground control center in real-time, so that the operator can keep abreast of the situation in the well, the data is transmitted by wireless communication and wired transmission, and has data processing and analysis functions, comprising data filtering, calibration, data visualization, and real-time reporting.

Specifically, the sensor system comprises the pressure sensor, the temperature sensor, the spectrum sensor, the turbidity sensor, the pH sensor, as follows:

### (1) The Pressure Sensor

the pressure sensor is a bending beam pressure sensor, which:

$$δ = \frac{P {L}^{3}}{3 E b {h}^{3}} ;$$

where δ is a deformation of a bending beam, L is a length of the bending beam, b is a breadth of the bending beam, h is a height of the bending beam, E is a Young's modulus of the bending beam, a relationship between fluid velocity and pressure is established according to a fluid dynamic equation:

$$∇ P = - {ρ}_{f} ∇ ( \frac{{V}_{f}^{2}}{2} ) ;$$

where P is an external pressure, ρ_{f} is a fluid density and V_{f} is a fluid velocity, meanwhile, the present invention also considers the stress influence on the pressure sensor in an oil and gas well environment, and constructs a stress equation:

$$σ = \frac{P {L}^{3}}{3 b {h}^{4}} ;$$

where σ is a stress of the pressure sensor in the oil and gas well environment, and the bending of the bending beam leads to the change of a resistance value, a relationship between a resistivity change Δσ and the stress is expressed as:

$$Δ ρ = \frac{ρ G P {L}^{3}}{3 E b {h}^{4} ( 1 - 2 v )} ;$$

where G is a shear modulus of a bending beam material, σ is a resistivity, and ν is a Poisson's ratio;

### (2) The Temperature Sensor

for the temperature sensor, the present invention considers a relationship between a thermal resistance value and a temperature, and builds a heat transfer model, the relationship between the thermal resistance value and the temperature is expressed as follows:

$$R ( T ) = {R}_{0} ( 1 + α ( T - {T}_{0} ) ) ;$$

where R(T) is a thermal resistance value at a temperature T, R₀ is a thermal resistance value at a reference temperature T₀, T₀ is the reference temperature of the thermal resistance, and α is a temperature coefficient, for the heat transfer model, the present invention constructs the following equation:

$$\hat{ρ} \hat{c} \frac{\partial T}{\partial t} = ∇ ( k ∇ T ) + Q ;$$

where \hat{ρ} is a material density, ĉ is a specific heat capacity, k is a conductivity, and Q is a heat source;

### (3) The Spectrum Sensor

for the spectrum sensor, the present invention describes a absorption, scattering, and refraction of light through spectral transmission and is modeled as follows:

$$I ( λ ) = {ω}_{1} ( ϕ ( λ ) ε ( λ ) {c}^{*} l ) + {ω}_{2} ( {I}_{0} ( λ ) {e}^{- ε ( λ ) {c}^{*} l} T ( λ ) + {I}_{s} ( λ ) ) ;$$

where I(λ) is a light intensity at a wavelength λ, ϵ(λ) is a molar absorption coefficient of the substance, c* is a substance concentration, l is an optical path length, ϕ is a light source intensity, I₀(λ) is an initial light intensity, T(λ) is a reflectivity, I_{S}(λ) is a scattered light intensity, ω₁ and ω₂ are adjustment coefficients, the temperature sensor has a specific spectral response ϵ(λ) and a sensitivity S(λ), and the light intensity I(λ) is converted into an electrical signal E(λ) by the following formula:

$$E ( λ ) = ε ( λ ) I ( λ ) S ( λ ) ;$$

where ϵ(λ) is a spectral response of the temperature sensor, S(λ) is a sensitivity of the temperature sensor;

### (4) The Turbidity Sensor

the turbidity sensor is modeled as follows:

$${I}_{s} ( θ ) = {I}_{0} {\vert \frac{f ( θ )}{r} \vert}^{2} ;$$

where θ is a scattered angle, I_{S}(λ) is a scattered intensity, r is a distance, f(θ) is a scattered amplitude function, and I₀ is an initial light intensity;

### (4) The pH Sensor

the pH sensor is modeled as follows:

$$\hat{E} = {E}_{0} - \frac{2.3 \; 03 QT}{z F} lg ( {aH}^{+} ) ;$$

where E₀ is a standard potential of an electrode, Q is a gas constant, z is a charge number of an electrode reaction, F is a Faraday constant, Ê is a potential, and aH⁺ is a hydrogen ion activity, this formula describes a relationship between the potential Ê and the hydrogen ion activity aH^{+,}pH is a measure of a negative logarithmic hydrogen ion concentration, expressed as: pH=−lg(aH⁺), a response time of the pH sensor is usually related to an electrolyte transport rate inside the electrode, the response time is described by an electrolyte transport equation:

$$\frac{d ( {aH}^{+} )}{dt} = - q ( {aH}^{+} - {aH}_{e q}^{+} ) ;$$

where q is a transmission rate constant,

$${H}_{e q}^{+}$$

is a hydrogen ion activity at equilibrium, and

$$\frac{d ( {aH}^{+} )}{dt}$$

is a hydrogen ion activity derivative of time t.

Specifically, the obtained sensor system data needs to be transmitted to the ground control center, in order to reduce a computational load of the ground control center, an edge computing technology is adopted, so that each sensor has a certain data processing ability to ensure the timeliness and reliability of data transmission, for each type of sensors, the following operations are performed:

an objective function Φ₁ᵢ of an i^{th} pressure sensor is constructed:

$${Φ}_{1 i} = \frac{{w}_{11} ( \frac{{P}_{i} {L}_{i}^{3}}{3 E {b}_{i} {h}_{i}^{3}} - min \{ \frac{{P}_{i} {L}_{i}^{3}}{3 E {b}_{i} {h}_{i}^{3}} {\vert}_{i = 1}^{N 1} \} )}{( {w}_{11} + {w}_{12} + {w}_{13} + {w}_{14} ) ( max \{ \frac{{P}_{i} {L}_{i}^{3}}{3 E {b}_{i} {h}_{i}^{3}} {\vert}_{i = 1}^{N 1} \} - min \{ \frac{{P}_{i} {L}_{i}^{3}}{3 E {b}_{i} {h}_{i}^{3}} {\vert}_{i = 1}^{N 1} \} )} + \frac{{w}_{12} ( - {ρ}_{f i} ∇ ( \frac{{V}_{f i}^{2}}{2} ) - min \{ - {ρ}_{f i} ∇ ( \frac{{V}_{f i}^{2}}{2} ) {\vert}_{i = 1}^{N 1} \} )}{\begin{matrix}( {w}_{11} + {w}_{12} + {w}_{13} + {w}_{14} ) \\ ( max \{ - {ρ}_{f i} ∇ ( \frac{{V}_{f i}^{2}}{2} ) {\vert}_{i = 1}^{N 1} \} - min \{ - {ρ}_{f i} ∇ ( \frac{{V}_{f i}^{2}}{2} ) {\vert}_{i = 1}^{N 1} \} )\end{matrix}} + \frac{{w}_{13} \frac{{P}_{i} {L}_{i}^{3}}{3 {b}_{i} {h}_{i}^{4}} - min \{ \frac{{P}_{i} {L}_{i}^{3}}{3 {b}_{i} {h}_{i}^{4}} {\vert}_{i = 1}^{N 1} \}}{( {w}_{11} + {w}_{12} + {w}_{13} + {w}_{14} ) ( max \{ \frac{{P}_{i} {L}_{i}^{3}}{3 {b}_{i} {h}_{i}^{4}} {\vert}_{i = 1}^{N 1} \} - min \{ \frac{{P}_{i} {L}_{i}^{3}}{3 {b}_{i} {h}_{i}^{4}} {\vert}_{i = 1}^{N 1} \} )} + \frac{{w}_{14}}{{w}_{11} + {w}_{12} + {w}_{13} + {w}_{14}} \frac{\frac{{ρ}_{i} {G}_{i} {P}_{i} {L}^{3}}{3 E {b}_{i} {h}_{i}^{4} ( 1 - 2 v )} - min \{ \frac{{ρ}_{i} {G}_{i} {P}_{i} {L}^{3}}{3 E {b}_{i} {h}_{i}^{4} ( 1 - 2 v )} {\vert}_{i = 1}^{N 1} \}}{max \{ \frac{{ρ}_{i} {G}_{i} {P}_{i} {L}^{3}}{3 E {b}_{i} {h}_{i}^{4} ( 1 - 2 v )} {\vert}_{i = 1}^{N 1} \} - min \{ \frac{{ρ}_{i} {G}_{i} {P}_{i} {L}^{3}}{3 E {b}_{i} {h}_{i}^{4} ( 1 - 2 v )} {\vert}_{i = 1}^{N 1} \}}$$

where w₁₁, w₁₂, w₁₃, and w₁₄ are a deformation weight, a pressure weight, a stress weight, and a resistivity change weight, respectively, Pᵢ is a length of the bending beam of the i^{th} pressure sensor, Lᵢ is a length of the bending beam of the i^{th} pressure sensor, bᵢ is a breadth of the bending beam of the i^{th} pressure sensor, hᵢ is a height of the bending beam of the i^{th} pressure sensor, V_{fi} is a fluid velocity of the i^{th} pressure sensor, Gᵢ is a shear modulus of the bending beam material of the i^{th} pressure sensor, ρᵢ is the resistivity of the i^{th} pressure sensor,

$$\vert \begin{matrix}N 1 \\ i = 1\end{matrix}$$

denotes that i starts from 1 to N1 ends, N1 is a total number of pressure sensors;

an objective function Φ₂ᵢ of an i^{th} temperature sensor is constructed:

$${Φ}_{2 i} = \frac{{R}_{0 i} ( 1 + α ( T - {T}_{0} ) ) - min \{ {R}_{0 i} ( 1 + α ( T - {τ}_{0} ) ) {\vert}_{i = 1}^{N 2} \}}{max \{ {R}_{0 i} ( 1 + α ( T - {T}_{0} ) ) {\vert}_{i = 1}^{N 2} \} - min \{ {R}_{0 i} ( 1 + α ( T - {T}_{0} ) ) {\vert}_{i = 1}^{N 2} \}} ;$$

where R₀ᵢ is a thermal resistance value of i^{th} temperature sensor at the reference temperature T₀,

$${\vert}_{i = 1}^{N 2}$$

denotes that i starts from 1 to N2 ends, and N2 is a total number of temperature sensors;

an objective function Φ₃ᵢ of an i^{th} spectrum sensor is constructed:

$${Φ}_{3 i} = \frac{\begin{matrix}( {ω}_{1} ( {ϕ}_{i} ( λ ) ε ( λ ) {c}_{i} * {l}_{i} ) + {ω}_{2} ( {I}_{0 i} ( λ ) {e}^{- ε ( λ ) {c}_{i} * {l}_{i}} {T}_{i} ( λ ) + {I}_{si} ( λ ) ) ) - \\ min \{ ( {ω}_{1} ( {ϕ}_{i} ( λ ) ε ( λ ) {c}_{i} * {l}_{i} ) + {ω}_{2} ( {I}_{0 i} ( λ ) {e}^{- ε ( λ ) {c}_{i} * {l}_{i}} {T}_{i} ( λ ) + {I}_{si} ( λ ) ) ) {\vert}_{i = 1}^{N 3} \}\end{matrix}}{\begin{matrix}max \{ ( {ω}_{1} ( {ϕ}_{i} ( λ ) ε ( λ ) {c}_{i} * ( {l}_{i} ) + {ω}_{2} ( {I}_{0 i} ( λ ) {e}^{- ε ( λ ) {c}_{i} * {l}_{i}} {T}_{i} ( λ ) + {I}_{si} ( λ ) ) ) {\vert}_{i = 1}^{N 3} \} - \\ min ( {ω}_{1} ( {ϕ}_{i} ( λ ) ε ( λ ) {c}_{i} * ( {l}_{i} ) + {ω}_{2} ( {I}_{0 i} ( λ ) {e}^{- ε ( λ ) {c}_{i} * {l}_{i}} {T}_{i} ( λ ) + {I}_{si} ( λ ) ) ) {\vert}_{i = 1}^{N 3} \}\end{matrix}} ;$$

where

$${c}_{i}^{*}$$

is a substance concentration of the i^{th} spectrum sensor, lᵢ is a optical path length of the i^{th} spectrum sensor, ϕᵢ is a light source intensity of the i^{th} spectrum sensor, I₀ᵢ(λ) is an initial light intensity of the i^{th} spectrum sensor, Tᵢ(λ) is a reflectivity of the i^{th} spectrum sensor, Iₛᵢ(λ) is a scattered light intensity of the i^{th} spectrum sensor,

$${\vert}_{i = 1}^{N 3}$$

denotes that i starts from 1 to N3 ends, and N3 is the total number of spectrum sensors;

an objective function Φ₄ᵢ of an i^{th} turbidity sensor is constructed:

$${Φ}_{4 i} = \frac{{I}_{oi} {\vert \frac{{f}_{i} ( θ )}{{r}_{i}} \vert}^{2} - min \{ {I}_{oi} {\vert \frac{{f}_{i} ( θ )}{{r}_{i}} \vert}^{2} {\vert}_{i = 1}^{N 4} \}}{max \{ {I}_{oi} {\vert \frac{{f}_{i} ( θ )}{{r}_{i}} \vert}^{2} {\vert}_{i = 1}^{N 4} \} - min \{ {I}_{oi} {\vert \frac{{f}_{i} ( θ )}{{r}_{i}} \vert}^{2} {\vert}_{i = 1}^{N 4} \}} ;$$

where I₀ᵢ(θ) is an initial light intensity of the i^{th} turbidity sensor, rᵢ is a distance of the i^{th} turbidity sensor, fᵢ(θ) is a scattered amplitude function of the i^{th} turbidity sensor,

$${\vert}_{i = 1}^{N 4}$$

denotes that i starts from 1 to N4 ends, and N4 is the total number of turbidity sensors;

an objective function Φ₅ᵢ of an i^{th} pH sensor is constructed:

$${Φ}_{5 i} = \frac{{E}_{oi} - \frac{2.303 QT}{zF} lg ( {aH}_{i}^{+} ) - min \{ {E}_{oi} - \frac{2.303 QT}{zF} lg ( {aH}_{i}^{+} ) {\vert}_{i = 1}^{N 5} \}}{max \text{} \{ {E}_{oi} - \text{} \frac{2.303 QT}{zF} \text{} lg ( \text{} {aH}_{i}^{+} ) {\vert}_{i = 1}^{N 5} \} - \text{} min \text{} \{ {E}_{oi} - \text{} \frac{2.303 QT}{zF} \text{} lg ( \text{} {aH}_{i}^{+} ) \text{} {\vert}_{i = 1}^{N 5} \text{} \}} ;$$

E₀ᵢ is a standard potential of the electrode of the i^{th} pH sensor, aH⁺ is a hydrogen ion activity of the i^{th} pH sensor,

$${\vert}_{i = 1}^{N 5}$$

denotes that i starts from 1 to N5 ends, and N5 is the total number of pH sensors;

the objective functions of pressure sensors, temperature sensors, spectrum sensors, turbidity sensors, and pH sensors are summarized as follows:

$$Φ = {o}_{1} {\sum }_{i = 1}^{N 1} {Φ}_{1 i} + {o}_{2} {\sum }_{i = 1}^{N 2} {Φ}_{2 i} + {o}_{3} {\sum }_{i = 1}^{N 3} {Φ}_{3 i} + {o}_{4} {\sum }_{i = 1}^{N 4} {Φ}_{4 i} + {o}_{5} {\sum }_{i = 1}^{N 5} {Φ}_{5 i} ;$$

where Φ is an objective function, and o₁, o₂, o₃, o₄, and o₅ are adjustment weights, in order to find the optimal objective function suitable for the oil and gas well testing environment, it is necessary to explore the adjustment weights, the steps are as follows:

$${o}_{id}^{p} = {o}_{i 5} + cos ( 2 π \frac{p}{h} ) {step}_{i} ;$$

where

$${o}_{id}^{p}$$

is a position of a i^{th} adjustment weight in a d dimension, d∈{1,2,3,4,5}, oᵢ₅ is a position of the i^{th}adjustment weight in the 5 dimensions, stepᵢ is a moving step of the i^{th} adjustment weight, h is a number of directions, h<360, p is a direction number, p∈[1, h], in order to expand the number of samples, the present invention expands the number of samples by convening: the current optimal adjustment weight is

$${o}_{id}^{best} ,$$

and the optimal adjustment weight

$${o}_{id}^{best}$$

is used to randomly select the sample points in the number domain radius M by Monte Carlo, each sample point approaches the objective function in steps of stepᵢ, which is expressed as follows:

$${o}_{jd}^{k + 1} = {o}_{jd}^{k} + {step}_{j} \frac{{o}_{jd}^{gbest , k} - {o}_{jd}^{k}}{\vert {o}_{jd}^{gbest , k} - {o}_{jd}^{k} \vert} ;$$

where

$${o}_{jd}^{k}$$

is a position of the j^{th} adjustment weight in the d dimension

$${o}_{jd}^{k + 1}$$

is a position of the j^{th} adjustment weight in the d dimension after the (k+1)^{th}iteration, stepⱼ is a moving step of the j^{th} adjustment weight,

$${o}_{jd}^{gbest , k}$$

is a global optimal position of the j^{th} adjustment weight in the d dimension after the k^{th} iteration, if a distance between the randomly selected sample points and the adjustment weight corresponding to the global optimal position is less than a threshold value, the defending and attacking behaviors will occur, that is, if the randomly selected sample points have higher fitness, the randomly selected sample points attack successfully, and the adjustment weight corresponding to the original global optimal position fails, the new randomly selected sample points will replace the position of the adjustment weight corresponding to the original global optimal position:

$${o}_{id}^{k + 1} = {o}_{id}^{k} + {ηstep}_{i} \vert {o}_{jd}^{Gbest , k} - {o}_{id}^{k} \vert ;$$

where

$${o}_{i d}^{k}$$

is a position of the current i^{th} djustment weight in the d dimension,

$${o}_{i d}^{k + 1}$$

a position of the i^{th} adjustment weight in the d dimension after the (k+1)^{th} iteration, η is a learning factor,

$${o}_{j d}^{Gbest , k}$$

is an ideal giopai opumai position of the i^{th} adjustment weight in the d dimension after the k^{th} iteration under a priori condition, and the optimal adjustment weight suitable for the oil and gas well environment is explored through convergence iteration.

Specifically, the ground control center has the functions of control, monitoring and management, which are used to monitor a state of quantum dot injection equipment, monitor a position and movement of delivery vehicles, and monitor a real-time process of quantum dot delivery, the ground control center is responsible for scheduling and planning a path of the delivery vehicle to ensure that the quantum dots can be accurately and efficiently delivered to an oil and gas well testing area, a stable communication link needs to be established between the ground control center and the delivery vehicle to transmit commands, data and real-time information, which is realized through wireless communication technology and satellite communication, the ground control center is responsible for controlling parameters in the delivery process to ensure the accuracy and efficiency of the delivery, the ground control center can monitor and respond to faults of the delivery equipment and vehicles in time, and perform maintenance tasks to ensure the normal operation of the system, the ground control center will record and store data during the delivery process, comprising real-time location, delivery parameters, and wellhead information, the ground control center needs to develop safety protocols and procedures to ensure the safety of the delivery process and prevent accidents and leakage.

Specifically, the ground control center has a monitoring and display system, a communications equipment, a calculation and control system, a fault detection and maintenance tool, and a geographic information system, as follows:
the monitoring and display system: for real-time monitoring of the delivery process, comprising surveillance cameras, sensors, and large screen display;
the communications equipment: used to establish communication links with delivery vehicles, comprising satellite communications, GPS trackings, and data transmissions;
the calculation and control system: used to control delivery parameters, path planning, and data processing, comprising high-performance computers and control terminals;
the fault detection and maintenance tools: tools for detecting equipment faults and performing remote maintenance and diagnoses;
the geographic information system: for map display, path planning, and geographic data analysis.

Advantageous effects of the present invention: the present invention uses quantum dot technology, which has very small size and highly adjustable optical properties, so as to achieve high-precision measurement and high-resolution monitoring of the formation, the sensor can capture small formation changes based on the characteristics of quantum dots, and provides reliable data for more accurate geological interpretation to monitor formation pressure and fluid properties, the multi-functionality increases the flexibility of the test system, and can be adapted to different types of oil and gas well testing; conventional oil and gas well testing usually requires days or weeks to obtain sufficient data, the quantum dot sensor of the present invention has real-time data acquisition capability, to achieve more rapid formation monitoring, which facilitates real-time decision-making and rapid response to formation changes, the present invention utilizes edge computing technology to impart computing power to the sensor system, reducing the cost of the testing process and reducing the testing cycle, thereby reducing the overall cost, and the quantum dot technology of the present invention are generally safer, do not involve high risk operations, and can generate richer data, facilitate deeper geological interpretation and analysis, and provide more insight into oil and gas well testing.

In order to reduce the calculation load of the ground control center, the edge calculation technology is adopted to make each sensor have a certain data processing capacity, so as to ensure the timeliness and reliability of data transmission, and each sensor is refined; mathematical models suitable for oil and gas well environment are established for pressure sensors, temperature sensors, spectrum sensors, turbidity sensors and pH sensors, respectively, for the pressure sensor, the effects of deformation, pressure, stress and resistivity changes on the pressure sensor are considered in the present invention, and the deformation weight, pressure weight, stress weight and resistivity change weight are used to dynamically adjust the proportion of each influencing factor, improving the adaptability of the system. In addition, the present invention also constructs an objective function, and in order to find the optimal adjustment weight, a heuristic algorithm suitable for the present invention is proposed, and the concepts of convening, defending and attacking are proposed, wherein the convening is taking the current optimal adjustment weight as the centre, and randomly select the sample points in the number domain radius M by Monte Carlo; the defending is taking the adjustment weight corresponding to the original global optimal position to participate in the calculation of the objective function; and the attacking is taking the calculation behaviour of the objective function when the distance between the randomly selected sample points and the adjustment weight corresponding to the global optimal position is less than a threshold value, and updating and iterating the position of the adjustment weight are performed, the convergence trend of the objective function is examined, and the optimal adjustment weight is obtained.

The present invention provides a quantum dot delivery system for oil and gas well testing with the advantages of high-precision, high-resolution, real-time data acquisition and multi-functionality, which can not only improve the output and return rate and reduce risks, but also contribute to environmental protection and sustainable development, therefore, the present invention has wide commercial value and social impact, and is expected to attract wide attention and application in the field of oil and gas exploration and testing.

Finally, it should be noted that the above embodiments are merely used for describing the technical solutions of the present invention, rather than limiting the same. Although the present invention has been described in detail with reference to the preferred embodiments, those of ordinary skill in the art should understand that the technical solutions of the present invention may still be modified. However, these modifications should not make the modified technical solutions deviate from the essence and scope of the technical solutions of the present invention.

What is claimed is:

1. A quantum dot delivery system for oil and gas well testing, comprises a quantum dot delivery device, a quantum dot labeling liquid, a sensor system and a ground control center, the quantum dot delivery device delivers quantum dot particles to oil and gas wells, the delivery device realizes the number and position of the particles by remote control to ensure that the particles are accurately introduced into the well, the quantum dot labeling liquid is used to introduce quantum dots into oil and gas well, the selection of labeling liquid is customized according to actual needs to adapt to different downhole environmental conditions, the sensor system is located in the well and is used to monitor the position, distribution and state of quantum dots in real-time, it comprises a pressure sensor, a temperature sensor, a spectrum sensor, a turbidity sensor and a pH sensor to collect data in the well, the ground control center is responsible for remote control of the operation of the delivery device, receive and process sensor data, to generate test reports, and real-time adjustment and optimization of the test process, it provides an interactive interface between the user and the system for monitoring and managing the entire test process;
the sensor system comprises the pressure sensor, the temperature sensor, the spectrum sensor, the turbidity sensor, and the pH sensor to monitor the position and distribution of quantum dots in the well, it is achieved by installing multiple sensors in the wellbore, these sensors are distributed at different depths and positions, the sensor system can transmit monitoring data to the ground control center in real-time, so that the operator can keep abreast of the situation in the well, the data is transmitted by wireless communication and wired transmission, and has certain data processing and analysis functions, comprising data filtering, calibration, data visualization, and real-time reporting;
the sensor system comprises the pressure sensor, the temperature sensor, the spectrum sensor, the turbidity sensor, the pH sensor, as follows:
(1) the pressure sensor
the pressure sensor is a bending beam pressure sensor, which:
$$δ = \frac{P {L}^{3}}{3 E b {h}^{3}} ;$$
where P is an external pressure, δ is a deformation of a bending beam, L is a length of the bending beam, b is a breadth of the bending beam, h is a height of the bending beam, E is a Young's modulus of the bending beam, a relationship between fluid velocity and pressure is established according to a fluid dynamic equation:
$$∇ P = - {ρ}_{f} ∇ ( \frac{{V}_{f}^{2}}{2} ) ;$$
where ρ_{f} is a fluid density and V_{f} is a fluid velocity, meanwhile, the present invention also considers the stress influence on the pressure sensor in an oil and gas well environment, and constructs a stress equation:
$$σ = \frac{P {L}^{3}}{3 b {h}^{4}} ;$$
where σ is a stress of the pressure sensor in the oil and gas well environment, and the bending of the bending beam leads to the change of a resistance value, a relationship between a resistivity change Δρ and the stress is expressed as:
$$Δ ρ = \frac{ρ G P {L}^{3}}{3 E b {h}^{4} ( 1 - 2 v )} ;$$
where G is a shear modulus of a bending beam material, ρ is a resistivity, and ν is a Poisson's ratio;
(2) the temperature sensor
for the temperature sensor, the present invention considers a relationship between a thermal resistance value and a temperature, and builds a heat transfer model, the relationship between the thermal resistance value and the temperature is expressed as follows:
$$R ( T ) = {R}_{0} ( 1 + α ( T - {T}_{0} ) ) ;$$
where R(T) is a thermal resistance value at a temperature T, R₀ is a thermal resistance value at a reference temperature T₀, T₀ is the reference temperature of the thermal resistance, and α is a temperature coefficient, for the heat transfer model, the present invention constructs the following equation:
$$\hat{ρ} \hat{c} \frac{\partial T}{\partial t} = ∇ ( k ∇ T ) + Q ;$$
where \hat{ρ} is a material density, ĉ is a specific heat capacity, k is a conductivity, and Q is a heat source;
(3) the spectrum sensor
for the spectrum sensor, the present invention describes a absorption, scattering, and refraction of light through spectral transmission and is modeled as follows:
$$I ( λ ) = {ω}_{1} ( ϕ ( λ ) ε ( λ ) c * l ) + {ω}_{2} ( {I}_{0} ( λ ) {e}^{- ε ( λ ) c * l} T ( λ ) + {I}_{s} ( λ ) ) ;$$
where I(λ) is a light intensity at a wavelength λ, ϵ(λ) is a molar absorption coefficient of the substance, c* is a substance concentration, l is an optical path length, ϕ is a light source intensity, I₀(λ) is an initial light intensity, T(λ) is a reflectivity, I_{S}(λ) is a scattered light intensity, ω₁ and ω₂ are adjustment coefficients, the temperature sensor has a specific spectral response ϵ(λ) and a sensitivity S(λ), and the light intensity I(λ) is converted into an electrical signal E(λ) by the following formula:
$$E ( λ ) = ϵ ( λ ) I ( λ ) S ( λ ) ;$$
where ϵ(λ) is a spectral response of the temperature sensor, S(λ) is a sensitivity of the temperature sensor;
(4) the turbidity sensor
the turbidity sensor is modeled as follows:
$${I}_{s} ( θ ) = {I}_{0} {\vert \frac{f ( θ )}{r} \vert}^{2} ;$$
where θ is a scattered angle, I_{S}(θ) is a scattered intensity, r is a distance, f(θ) is a scattered amplitude function, and I₀ is an initial light intensity;
(4) the pH sensor
the pH sensor is modeled as follows:
$$\hat{E} = {E}_{0} - \frac{2.303 QT}{z F} lg ( {aH}^{+} ) ;$$
where E₀ is a standard potential of an electrode, Q is a gas constant, z is a charge number of an electrode reaction, F is a Faraday constant, Ê is a potential, and aH⁺ is a hydrogen ion activity, this formula describes a relationship between the potential Ê and the hydrogen ion activity aH⁺, pH is a measure of a negative logarithmic hydrogen ion concentration, expressed as: pH=−lg(aH⁺), a response time of the pH sensor is usually related to an electrolyte transport rate inside the electrode, the response time is described by an electrolyte transport equation:
$$\frac{d ( a {H}^{+} )}{dt} = - q ( {aH}^{+} - a {H}_{eq}^{+} ) ;$$
where q is a transmission rate constant,
$${H}_{e q}^{+}$$
is a hydrogen ion activity at equilibrium, and
$$\frac{d ( a {H}^{+} )}{dt}$$
is a hydrogen ion activity derivative of time t;
the obtained sensor system data needs to be transmitted to the ground control center, in order to reduce a computational load of the ground control center, an edge computing technology is adopted, so that each sensor has a certain data processing ability to ensure the timeliness and reliability of data transmission, for each type of sensors, the following operations are performed:
an objective function Φ₁ᵢ of an i^{th} pressure sensor is constructed:
$${Φ}_{1 i} = \frac{{w}_{11} ( \frac{{P}_{i} {L}_{i}^{3}}{3 E {b}_{i} {h}_{i}^{3}} - min \{ \frac{{P}_{i} {L}_{{i}^{3}}}{3 E {b}_{i} {h}_{i}^{3}} {\vert}_{i = 1}^{N 1} \} )}{\begin{matrix}( {w}_{11} + {w}_{12} + {w}_{13} + {w}_{14} ) \\ ( max \{ \frac{{P}_{i} {L}_{i}^{3}}{3 E {b}_{i} {h}_{i}^{3}} {\vert}_{i = 1}^{N 1} \} - min \{ \frac{{P}_{i} {L}_{i}^{3}}{3 E {b}_{i} {h}_{i}^{3}} {\vert}_{i = 1}^{N 1} \} )\end{matrix}} + \frac{{w}_{12} ( - {ρ}_{f i} ∇ ( \frac{{V}_{f i}^{2}}{2} ) - min \{ - {ρ}_{{f}_{i}} ∇ ( \frac{{V}_{fi}^{2}}{2} ) {\vert}_{i = 1}^{N 1} \} )}{\begin{matrix}( {w}_{11} + {w}_{12} + {w}_{13} + {w}_{14} ) \\ ( max \{ - {ρ}_{f i} ∇ ( \frac{{V}_{f i}^{2}}{2} ) {\vert}_{i = 1}^{N 1} \} - min \{ - {ρ}_{f i} ∇ ( \frac{{V}_{f i}^{2}}{2} ) {\vert}_{i = 1}^{N 1} \} )\end{matrix}} + \frac{{w}_{13} \frac{{P}_{i} {L}_{i}^{3}}{3 {b}_{i} {h}_{i}^{4}} - min \{ \frac{{P}_{i} {L}_{i}^{3}}{3 {b}_{i} {h}_{i}^{4}} {\vert}_{i = 1}^{N 1} \}}{( {w}_{11} + {w}_{12} + {w}_{13} + {w}_{14} ) ( max \{ \frac{{P}_{i} {L}_{i}^{3}}{3 {b}_{i} {h}_{i}^{4}} {\vert}_{i = 1}^{N 1} \} - min \{ \frac{{P}_{i} {L}_{i}^{3}}{3 {b}_{i} {h}_{i}^{4}} {\vert}_{i = 1}^{N 1} \} )} + \frac{{w}_{14}}{{w}_{11} + {w}_{12} + {w}_{13} + {w}_{14}} \frac{\frac{{ρ}_{i} {G}_{i} {P}_{i} {L}^{3}}{3 E {b}_{i} {h}_{i}^{4} ( 1 - 2 v )} - min \{ \frac{{ρ}_{i} {G}_{i} {P}_{i} {L}^{3}}{3 E {b}_{i} {h}_{i}^{4} ( 1 - 2 v )} {\vert}_{i = 1}^{N 1} \}}{max \{ \frac{{ρ}_{i} {G}_{i} {P}_{i} {L}^{3}}{3 E {b}_{i} {h}_{i}^{4} ( 1 - 2 v )} {\vert}_{i = 1}^{N 1} \} - min \{ \frac{{ρ}_{i} {G}_{i} {P}_{i} {L}^{3}}{3 E {b}_{i} {h}_{i}^{4} ( 1 - 2 v )} {\vert}_{i = 1}^{N 1} \}} ;$$
where w₁₁, w₁₂, w₁₃, and w₁₄ are a deformation weight, a pressure weight, a stress weight, and a resistivity change weight, respectively, Pᵢ is a length of the bending beam of the i^{th} pressure sensor, Lᵢ is a length of the bending beam of the ith pressure sensor, bᵢ is a breadth of the bending beam of the i^{th} pressure sensor, hᵢ is a height of the bending beam of the i^{th} pressure sensor, V_{fi} is a fluid velocity of the i^{th} pressure sensor, Gᵢ is a shear modulus of the bending beam material of the ith pressure sensor, ρᵢ is the resistivity of the i^{th} pressure sensor,
$${\vert}_{i = 1}^{N 1}$$
denotes that i starts from 1 to N1 ends, N1 is a total number of pressure sensors;
an objective function Φ₂ᵢ of an i^{th} temperature sensor is constructed:
$${Φ}_{2 i} = \frac{{R}_{0 i} ( 1 + α ( T - {T}_{0} ) ) - min \{ {R}_{0 i} ( 1 + α ( T - {T}_{0} ) ) {\vert}_{i = 1}^{N 2} \}}{max \{ {R}_{0 i} ( 1 + α ( T - {T}_{0} ) ) {\vert}_{i = 1}^{N 2} \} - min \{ {R}_{0 i} ( 1 + α ( T - {T}_{0} ) ) {\vert}_{i = 1}^{N 2} \}} ;$$
where R₀ᵢ is a thermal resistance value of i^{th} temperature sensor at the reference temperature T₀,
$${\vert}_{i = 1}^{N 2}$$
denotes that i starts from 1 to N2 ends, and N2 is a total number of temperature sensors;
an objective function Φ₃ᵢ of an i^{th} spectrum sensor is constructed:
$${Φ}_{3 i} = \frac{\begin{matrix}( {ω}_{1 ( {ϕ}_{i} ( λ ) ε ( λ ) {c}_{{i}^{*}} {l}_{i} ) + {ω}_{2} ( {I}_{0 i} ( λ ) {e}^{- ε ( λ ) {c}_{i}}} * {l}_{{i}_{{T}_{i}}} ( λ ) + {I}_{s i} ( λ ) ) ) - \\ min \{ {ω}_{1} ( {ϕ}_{i} ( λ ) ε ( λ ) {c}_{i} * {l}_{i} ) + {ω}_{2} ( {I}_{0 i} ( λ ) {e}^{- ε ( λ ) {c}_{i}} * {l}_{{i}_{{T}_{i}}} ( λ ) + {I}_{si} ( λ ) ) ) {\vert}_{i = 1}^{N 3} \}\end{matrix}}{\begin{matrix}max \\ \{ ( {ω}_{1} ( {ϕ}_{i} ( λ ) ε ( λ ) {c}_{i} * {l}_{i} ) + {ω}_{2} ( {I}_{0 i} ( λ ) {e}^{- ε ( λ ) {c}_{i} *} {{l}_{i}}_{{T}_{i}} ( λ ) + {I}_{s i} ( λ ) ) ) {\vert}_{i = 1}^{N 3} \} - \\ min \{ ( {ω}_{1} ( {ϕ}_{i} ( λ ) ε ( λ ) {c}_{i} * {l}_{i} ) + {ω}_{2} ( {I}_{0 i} ( λ ) {e}^{- ε ( λ ) {c}_{i}} * {l}_{{i}_{{T}_{i}} ( ( λ ) + {I}_{s i} ( λ ) ) )} {\vert}_{i =}^{N} \text{?}\end{matrix}}$$
$$\text{?} \text{indicates text missing or illegible when filed}$$
where
$${c}_{i}^{*}$$
is a substance concentration of the i^{th}spectrum sensor, lᵢ is an optical path length of the i^{th} spectrum sensor, ϕᵢ is a light source intensity of the i^{th} spectrum sensor, I₀ᵢ (λ) is an initial light intensity of the i^{th} spectrum sensor, Tᵢ(λ) is a reflectivity of the i^{th} spectrum sensor, Iₛᵢ(λ) is a scattered light intensity of the i^{th} spectrum sensor,
$${\vert}_{i = 1}^{N 3}$$
denotes that i starts from 1 to N3 ends, and N3 is the total number of spectrum sensors;
an objective function Φ₄ᵢ of an i^{th} turbidity sensor is constructed:
$${Φ}_{4 i} = \frac{{I}_{0 i} {\vert \frac{{f}_{i} ( θ )}{{r}_{i}} \vert}^{2} - min \{ {I}_{0 i} {\vert \frac{{f}_{i} ( θ )}{{r}_{i}} \vert}^{2} {\vert}_{i = 1}^{N 4} \}}{max \{ {I}_{0 i} {\vert \frac{{f}_{i} ( θ )}{{r}_{i}} \vert}^{2} {\vert}_{i = 1}^{N 4} \} - min \{ {I}_{0 i} {\vert \frac{{f}_{i} ( θ )}{{r}_{i}} \vert}^{2} {\vert}_{i = 1}^{N 4} \}} ;$$
where l₀ᵢ(θ) is an initial light intensity of the i^{th} turbidity sensor, rᵢ is a distance of the i^{th} turbidity sensor, fᵢ(θ) is a scattered amplitude function of the i^{th} turbidity sensor,
$${\vert}_{i = 1}^{N 4}$$
denotes that i starts from 1 to N4 ends, and N4 is the total number of turbidity sensors;
an objective function Φ₅ᵢ of an i^{th} pH sensor is constructed:
$${Φ}_{5 i} = \frac{{E}_{0 i} - \frac{2.303 QT}{zF} l g ( {aH}_{i}^{+} ) - min \{ {E}_{0 i} - \frac{2.303 QT}{zF} l g ( {aH}_{i}^{+} ) {\vert}_{i = 1}^{N 5} \}}{\begin{matrix}max \{ {E}_{0 i} - \frac{2.303 QT}{zF} l g ( {aH}_{i}^{+} ) {\vert}_{i = 1}^{N 5} \} - \\ min \{ {E}_{0 i} - \frac{2.303 QT}{zF} l g ( {aH}_{i}^{+} ) {\vert}_{i = 1}^{N 5} \}\end{matrix}} ;$$
E₀ᵢ is a standard potential of the electrode of the i^{th} pH sensor, aH⁺ is a hydrogen ion activity of the i^{th} pH sensor,
$${\vert}_{i = 1}^{N 5}$$
denotes that i starts from 1 to N5 ends, and N5 is the total number of pH sensors;
the objective functions of pressure sensors, temperature sensors, spectrum sensors, turbidity sensors, and pH sensors are summarized as follows:
$$Φ = \text{} {o}_{1} {\sum }_{i = 1}^{N 1} {Φ}_{1 i} + {o}_{2} {\sum }_{i = 1}^{N 2} {Φ}_{2 i} + {o}_{3} {\sum }_{i = 1}^{N 3} {Φ}_{3 i} + {o}_{4} {\sum }_{i = 1}^{N 4} {Φ}_{4 i} + {o}_{5} {\sum }_{i = 1}^{N 5} {Φ}_{5 i} ;$$
where Φ is an objective function, and o₁, o₂, o₃, o₄, and o₅ are adjustment weights, in order to find the optimal objective function suitable for the oil and gas well testing environment, it is necessary to explore the adjustment weights, the steps are as follows:
$${o}_{i d}^{p} = {o}_{i 5} + cos ( 2 π \frac{p}{h} ) {step}_{i} ;$$
where
$${o}_{i d}^{p}$$
is a position of a i^{th} adjustment weight in a d dimension, d∈{1,2,3,4,5}, oᵢ₅ is a position of the i^{th} adjustment weight in the 5 dimensions, stepᵢ is a moving step of the i^{th} adjustment weight, h is a number of directions, h<360, p is a direction number, p∈[1, h], in order to expand the number of samples, the present invention expands the number of samples by convening: the current optimal adjustment weight is
$${o}_{i d}^{best} ,$$
and the optimal adjustment weight
$${o}_{i d}^{best}$$
is used to randomly select we sample points in the number domain radius M by Monte Carlo, each sample point approaches the objective function in steps of stepᵢ, which is expressed as follows:
$${o}_{jd}^{k + 1} = {o}_{jd}^{k} + {step}_{j} \frac{{o}_{jd}^{gbest , k} - {o}_{jd}^{k}}{\vert {o}_{jd}^{gbest , k} - {o}_{jd}^{k} \vert} ;$$
where
$${o}_{j d}^{k}$$
is a position of the j^{th} adjustment weight in the d dimension
$${o}_{j d}^{k + 1}$$
is a position of the j^{th} adjustment weight in the d dimension after the (k+1)^{th} iteration stepⱼ is a moving step of the j^{th} adjustment weight,
$${o}_{j d}^{gbest , k}$$
is a global optimal position of the j^{th} adjustment weight in the d dimension after the k^{th} iteration, if a distance between the randomly selected sample points and the adjustment weight corresponding to the global optimal position is less than a threshold value, the defending and attacking behaviors will occur, that is, if the randomly selected sample points have higher fitness, the randomly selected sample points attack successfully, and the adjustment weight corresponding to the original global optimal position fails, the new randomly selected sample points will replace the position of the adjustment weight corresponding to the original global optimal position:
$${o}_{i d}^{k + 1} = {o}_{i d}^{k} + η {step}_{i} \vert {o}_{j d}^{G best , k} - {o}_{i d}^{k} \vert ;$$
where
$${o}_{i d}^{k}$$
is a position of the current i^{th} adjustment in the d dimension
$${o}_{i d}^{k + 1}$$
is a position of the i^{th} adjustment weight in the d dimension after the (k+1)^{th} iteration, η is a learning factor,
$${o}_{j d}^{G best , k}$$
is an ideal global optimal position of the i^{th} adjustment weight in the d dimension after the k^{th} iteration under a priori condition, and the optimal adjustment weight suitable for the oil and gas well environment is explored through convergence iteration.

2. The quantum dot delivery system for oil and gas well testing according to claim 1, the quantum dot delivery device accurately introduces quantum dot particles into oil and gas wells, its functions comprise: delivery precision control, remote operation, and delivery position control, the quantum dot delivery device designs a highly accurate delivery mechanism to ensure the accurate delivery of quantum dot particles, comprising precision control valves, programmable delivery devices, and quantitative pump equipment, these devices can operate reliably in the downhole environment and accurately control the number and speed of quantum dots according to requirements; the delivery device is remotely operated through the ground control center, and the operator remotely sets the delivery parameters, comprising a delivery speed and a delivery volume, the remote operation makes the delivery process more flexible and controllable; the delivery device also controls the delivery position of the quantum dots, due to different positions will produce different test results, the accuracy and repeatability of the test are ensured by accurately controlling the delivery position.

3. The quantum dot delivery system for oil and gas well testing according to claim 2, the delivery position control function, a defined c (x,y) denotes a concentration of quantum dots in a wellbore, where x is a spatial coordinate and t is a time, a convection-diffusion equation is used to describe a transmission of quantum dots:
$$\frac{\partial c ( x , t )}{\partial t} + ∇ ( u ( x , t ) c ( x , t ) ) = D {∇}^{2} c ( x , t ) ;$$
where
$$\frac{\partial c ( x , t )}{\partial t}$$
is a time derivative, ∇ is a gradient calculation, u(x, t) is a fluid velocity vector, and D is a diffusion coefficient, then, a control strategy is established to adjust a delivery position of the quantum dots, a target delivery position is set to x_{target}, and a controller is defined to adjust a fluid velocity to achieve a target position control:
$$u ( x , t ) = {u}_{b a s e} + {u}_{control} ( x , t ) ;$$
where u_{base}(x, t) is a basic fluid velocity, and u_{control}(x, t) is a control input, in order to achieve position control, an optimal control theory is used to design the control input u_{control}(x, t) as an integration of minimizing the error between the delivery position and a target position:
$$J = {\int }_{0}^{T} {[ c ( x ( t ) , t ) - {c}_{target} ( x ( t ) ) ]}^{2} dt ;$$
where J is the integration of minimizing the error between the delivery position and the target position, x(t) is a delivery position under time t, and c_{target} is a target concentration distribution.

4. The quantum dot delivery system for oil and gas well testing according to claim 1, the quantum dot labeling liquid comprises quantum dot particles as a labeling substance, in addition to quantum dots, the labeling liquid also comprises solvents, stabilizers, and surfactants to ensure a dispersion stability and a fluidity of quantum dots;
spectral characteristics of quantum dot labeling liquid determine the detection and monitoring methods of quantum dots, quantum dots have tunable emission wavelengths, which make them emit light in different wavelength ranges to meet different test and detection requirements;
the labeling liquid ensures that the quantum dots can remain dispersed without agglomeration or precipitation, so as to be evenly introduced into the well during the test process, and the labeling liquid needs to have appropriate fluidity to be accurately introduced into the well through the delivery device;
the labeling liquid also has sufficient chemical stability to prevent adverse reactions or degradation with substances in the well, the labeling liquid must be used safely in the downhole environment and will not cause harm to the operator, wellbore, or environment.

5. The quantum dot delivery system for oil and gas well testing according to claim 1, the ground control center has the functions of control, monitoring and management, which are used to monitor a state of quantum dot injection equipment, monitor a position and movement of delivery vehicles, and monitor a real-time process of quantum dot delivery, the ground control center is responsible for scheduling and planning a path of the delivery vehicle to ensure that the quantum dots can be accurately and efficiently delivered to an oil and gas well testing area, a stable communication link needs to be established between the ground control center and the delivery vehicle to transmit commands, data and real-time information, which is realized through wireless communication technology and satellite communication, the ground control center is responsible for controlling parameters in the delivery process to ensure the accuracy and efficiency of the delivery, the ground control center can monitor and respond to faults of the delivery equipment and vehicles in time, and perform maintenance tasks to ensure the normal operation of the system, the ground control center will record and store data during the delivery process, comprising real-time location, delivery parameters, and wellhead information, the ground control center needs to develop safety protocols and procedures to ensure the safety of the delivery process and prevent accidents and leakage.

6. The quantum dot delivery system for oil and gas well testing according to claim 1, the ground control center has a monitoring and display system, a communications equipment, a calculation and control system, a fault detection and maintenance tool, a geographic information system, as follows:
the monitoring and display system: for real-time monitoring of the delivery process, comprising surveillance cameras, sensors, and large screen display;
the communications equipment: used to establish communication links with delivery vehicles, comprising satellite communications, GPS trackings, and data transmissions;
the calculation and control system: used to control delivery parameters, path planning, and data processing, comprising high-performance computers and control terminals;
the fault detection and maintenance tools: tools for detecting equipment faults and performing remote maintenance and diagnoses;
the geographic information system: for map display, path planning, and geographic data analysis.
